(19) United States
(12) Patent Application Publication
(10) Pub. No.: US 2002/0197066 A1
(43) Pub. Date: Dec. 26, 2002

(54) Apparatus and method of recording/reproducing digital broadcast data

(75) Inventors: Sung Ryun Cho, Seoul (KR); Jea Yong Yoo, Seoul (KR); Kand Soo Seo, Kyunggi-do (KR); Byung Jin Kim, Kyunggl-do (KR)

Correspondence Address: LEE & HONG, 11th Floor, 221 N. Figueroa Street, Los Angeles, CA, 90012, US

(73) Assignee: LG Electronics Inc.

(21) Appl. No.: 10/176,107

(22) Filed: Jun. 20, 2002

(30) Foreign Application Priority Data
Jun. 21, 2001 (KR) 2001-35397

(51) Int. Cl. H04N 5/76

(52) U.S. Cl. 386/111; 386/131

(57) ABSTRACT

The present invention relates to method and apparatus of recording/reproducing a non-MPEG formatted digital TV broadcast signal on/from a writable medium. The present recording method, when a digital TV broadcast signal composed of DirecTV transport packets is received, extracts data contained in DirecTV transport packets to form an A/V elementary stream, packetizes the A/V elementary stream into PES (Packetized Elementary Stream) packets, slices the PES packets into 184-byte stream pieces to produce a series of 188-byte Transport Packets defined in MPEG standard, and writes the series of Transport Packets sequentially on a recording medium. The present method can record a non-MPEG type of transport stream in MPEG recording format and reproduce the recorded transport stream to original DirecTV transport stream, whereby an applicability of a digital recorder is improved.

### BACKGROUND OF THE INVENTION

1. Field of the Invention

The present invention relates to method and apparatus of recording a non-MPEG formatted digital TV broadcast signal on a writable medium such as a writable high-density digital versatile disk (called ‘HD-DVD’ hereinafter). The present invention further relates to method and apparatus of reproducing MPEG-formatted data stream, in which non-MPEG formatted packets are encapsulated, from a recording medium.

2. Description of the Related Art

FIG. 1 is an illustrative format of MPEG2 (Moving Picture Experts Group 2) transport stream. An MPEG2 transport stream consists of a series of Transport Packets (abbreviated to ‘M-TP’ hereinafter). An M-TP, 188-byte long, consists of 4-byte prefix, namely, header and 184-byte payload, which includes adaptation field optionally as shown in FIG. 1, or 184-byte adaptation field. The adaptation field includes program clock reference (PCR) used for system clock synchronization. The 4-byte header includes a sync byte (SB), a transport error indicator (TEI), a packet ID (PID), and so forth.

An MPEG2 transport stream structured as above is adopted as standard in most of digital TV broadcast systems.

Therefore, a digital video recorder for recording digital TV broadcast programs is likely to be developed to record digital TV broadcast programs transmitted in the form of M-TPs. According to a provisional standard thereof, a digital video recorder records M-TPs sequentially as they are received while adding 4-byte arrival time stamp (TS) to each M-TP or records M-TPs sequentially as they are received without any TS. And, in reproduction mode, it reads recorded M-TPs and transmits them one after another to a picture presenting machine such as a digital TV set based on each interval between adjacent TSs added therein.

However, there are several digital TV broadcast systems not adopting MPEG format as standard. DirecTV is one of them. FIG. 2 is an illustrative transport stream format defined in DirecTV. A DirecTV transport stream consists of a series of transport packets (abbreviated to ‘D-TP’ hereinafter). A D-TP, 130-byte long, consists of 2-byte prefix, namely, header and 128-byte transport block. A transport block consists of continuity counter (CC) of packets belonging to same service channel ID (SCID), a header designator (HD), and payload including chunks of auxiliary or MPEG data.

A 2-byte header includes a control flag indicating whether data is scrambled or not, the SCID, and so on. The DirecTV system has an RTS (Reference Time Stamp) type of packet, which is illustratively shown in FIG. 3, including 5-byte RTS. RTS packets are transmitted periodically at 10 Hz and the RTS is carried through an auxiliary data block (ADB).

Besides the stream format defined in the DirecTV system, there are a variety of stream formats other than MPEG format. The same as the DirecTV format, every packet unit of the various of stream formats is different in length from an M-TP defined in MPEG format.

Therefore, the digital video recorder developed to record MPEG-formatted data stream as explained before is not able to record non-MPEG formatted digital TV broadcast programs as received.

### SUMMARY OF THE INVENTION

It is an object of the present invention to provide method and apparatus of recording a non-MPEG formatted transport stream in recording format defined in the MPEG standard.

It is another object of the present invention to provide method and apparatus of reproducing a recorded data stream where non-MPEG formatted transport packets are encapsulated in MPEG-formatted transport packets and transmitting the reproduced data stream in an original non-MPEG format.

A method of recording a digital broadcast signal in accordance with the present invention is characterized in that it comprises the steps of: receiving a digital broadcast signal composed of transport packets of a first format; restoring an A/V elementary stream from data contained in the received transport packets of the first format; slicing the restored A/V elementary stream into a predetermined-sized stream pieces to produce transport packets of a second format wherein a transport packet of the first format is different in length from that of the second format; and writing the produced transport packets of the second format on a recording medium.

A method of reproducing digital broadcast data from a recording medium in accordance with the present invention is characterized in that it comprises the steps of: reading a data stream from the recording medium and making transport packets of a second format out of the read data stream; restoring an A/V elementary stream from data contained in the transport packets of the second format; slicing the restored A/V elementary stream into a predetermined-sized stream pieces to produce transport packets of a first format wherein a transport packet of the first format is different in length from that of the second format; and transmitting the produced transport packets of the first format.

An apparatus of recording digital broadcast signal in accordance with the present invention is characterized in that it comprises: a data converter receiving a digital broadcast signal composed of transport packets of a first format, restoring an A/V elementary stream from data contained in the received transport packets of the first format, and slicing the restored A/V elementary stream into a predetermined-sized stream pieces to produce transport packets of a second format; and writing means writing the produced transport packets of the second format on a recording medium, wherein a transport packet of the first format is different in length from that of the second format.

An apparatus of reproducing digital broadcast data from a recording medium is characterized in that it comprises: reading means reading a data stream from a recording medium and making transport packets of a second format out of the read data stream; and a data converter restoring an A/V elementary stream from data contained in the transport packets of the second format, slicing the restored A/V elementary stream into a predetermined-sized stream pieces to produce transport packets of a first format, and transmitting the produced transport packets of the first format, wherein a transport packet of the first format being different in length from that of the second format.

### BRIEF DESCRIPTION OF THE DRAWINGS

The accompanying drawings, which are included to provide a further understanding of the present invention, illustrate the preferred embodiments of the invention, and together with the description, serve to explain the principles of the present invention, and wherein:

FIG. 1 is an illustrative format of MPEG2 (Moving Picture Experts Group 2) transport stream;

FIGS. 2 and 3 are illustrative transport stream formats defined in DirecTV, one of digital TV broadcast systems;

FIG. 4 is a block diagram of an embodiment of an apparatus recording digital TV broadcast programs in accordance with the present invention;

FIG. 5 is a schematically-drawn process of encapsulating DirecTV data stream in an MPEG2 transport stream in accordance with the present invention;

FIG. 6 is a block diagram of an apparatus reproducing a data stream recorded in accordance with the present invention; and

FIG. 7 is a block diagram of another apparatus reproducing a data stream recorded in accordance with the present invention.

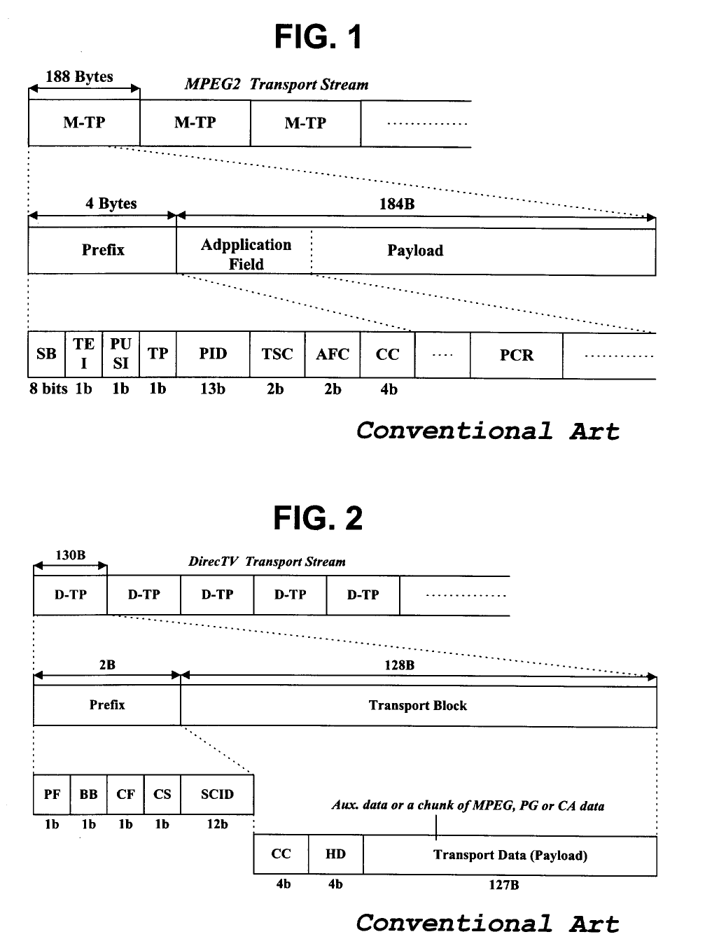

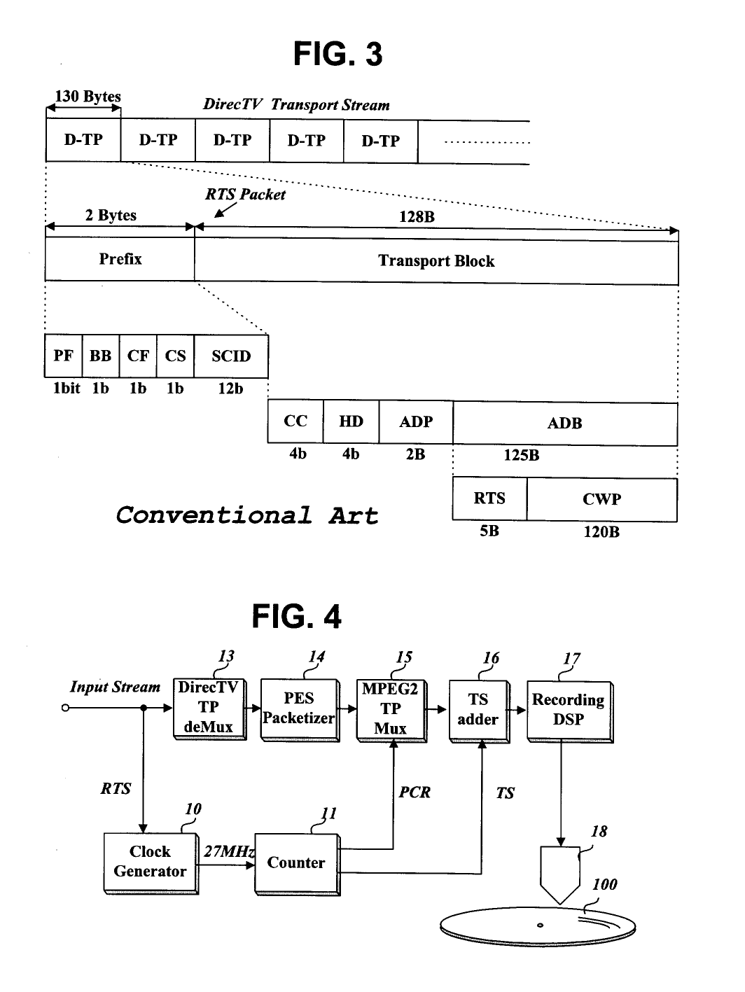

### DETAILED DESCRIPTION OF THE PREFERRED EMBODIMENT

In order that the invention maybe fully understood, a preferred embodiment thereof will now be described with reference to the accompanying drawings.

In preferred embodiments of the present invention, it is supposed that a non-MPEG stream format is one defined in DirecTV standard.

FIG. 4 is a block diagram of an embodiment of an apparatus recording digital TV broadcast programs in accordance with the present invention.

The recording apparatus of FIG. 4 comprises a clock generator 10 synchronizing its 27 MHz oscillating clock with RTS time carried periodically by a DirecTV transport stream; a counter 11 counting the 27 MHz clock to produce Program Clock Reference (PCR) as well as a 4-byte arrival TS; a DirecTV TP demux 13 demultiplexing the DirecTV transport stream composed of a series of 130-byte D-TPs to restore A/V elementary stream contained in the D-TPs; a PES packetizer 14 packetizing the restored A/V elementary stream into a series of PES (Packetized Elementary Stream) packets; an MPEG2 TP mux 15 slicing the series of PES packets into 184-byte stream pieces and adding 4-byte header in front of each 184-byte stream piece to make a series of 188-byte M-TPs; a TS adder 16 reading 4-byte count of the counter 11 and adding it as respective receiving time stamps (TSs) in front of an M-TP outputted from the MPEG2 TP mux 15; a recording DSP (Digital Signal Processor) 17 converting the output data from the TS adder 16 to writing signals suitable to disk record; and an optical pickup 18 forming mark/space patterns on a writable HD-DVD 100 in accordance with the writing signals.

The clock generator 10 synchronizes the 27 MHz internal clock with 5-byte RTS time which is received at 10 Hz through an ADB of a RTS packet as mentioned before. The counter 11 continuously counts the synchronized 27 MHz clock with four bytes, namely, 2³² modulo.

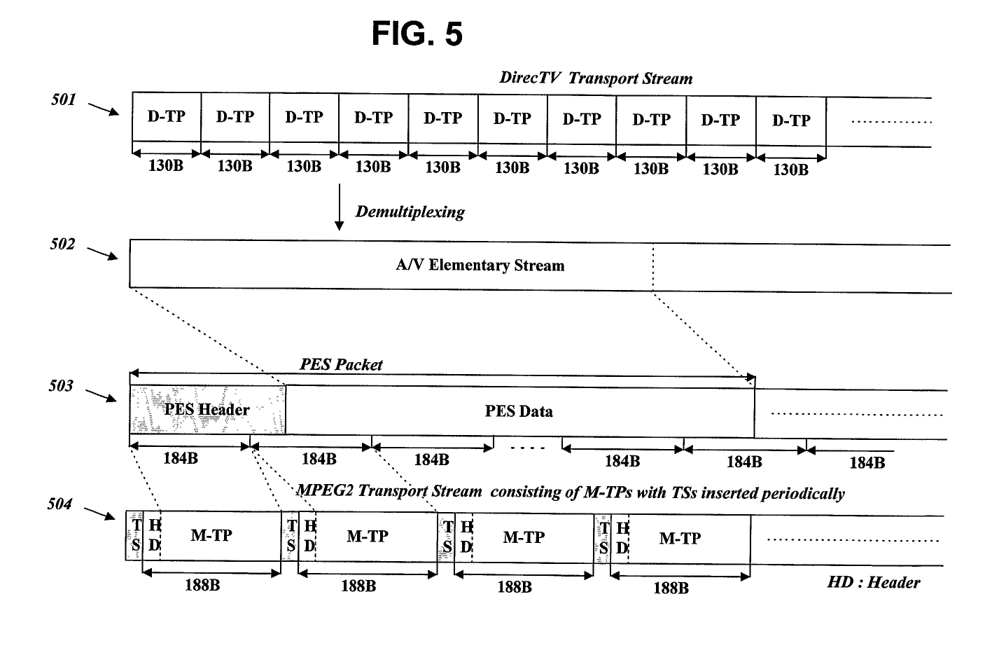

In recording mode, while receiving a DirecTV transport stream 501, namely, a series of D-TPs shown in FIG. 5, the DirecTV TP demux 13 separates each D-TP into 2-byte header and a 128-byte transport block (TB) and demultiplexes each TB into video and/or audio stream piece which constitutes an A/V elementary stream 502.

The PES packetizer 14 analyzes the A/V elementary stream 502 and composes a PES packet 503 with every some data of A/V elementary stream of appropriate length. At this time, a PES header is added at the head of each PES packet to form a complete PES packet. A Presentation Time Stamp (PTS) for a picture included in a PES packet is written in a PES header. A Decoding Time Stamp (DTS) for an included picture is optionally written in a PES header. The length of a PES packet, namely, both of PES header and PES data is also written in a PES header, and especially, the information indicating that a non-MPEG transport stream is encapsulated in PES data is further written in a PES header.

The MPEG2 TP mux 15 slices the series of PES packets 502 into successive 184-byte stream pieces and then adds 4-byte header to each 184-byte stream piece to produce a series of 188-byte M-TPs. In this M-TP packetizing process, the MPEG2 TP mux 15 reads the current count of the counter 11 and writes the read count as a PCR in an adaptation field allocated in a payload of an M-TP at a predetermined interval, e.g., 10 msec.

Whenever an M-TP is received from the MPEG2 TP mux 14 the TS reads the 4-byte current count of the counter 11 and adds it in front of the received 188-byte M-TP.

Consequently, a data stream 504 shown in FIG. 5 is outputted from the TS adder 16.

Through the above-explained process, the received DirecTV transport stream 501 is converted to the MPEG2 stream format 504. The recording DSP 17 produces respective writing signals corresponding to the converted MPEG2 transport stream 504. The produced writing signals form successive mark and space patterns on a data recording area of the writable HD-DVD 100 through the optical pickup 18.

Next, apparatus and method of reproducing data stream recorded in accordance with the above embodiment are explained.

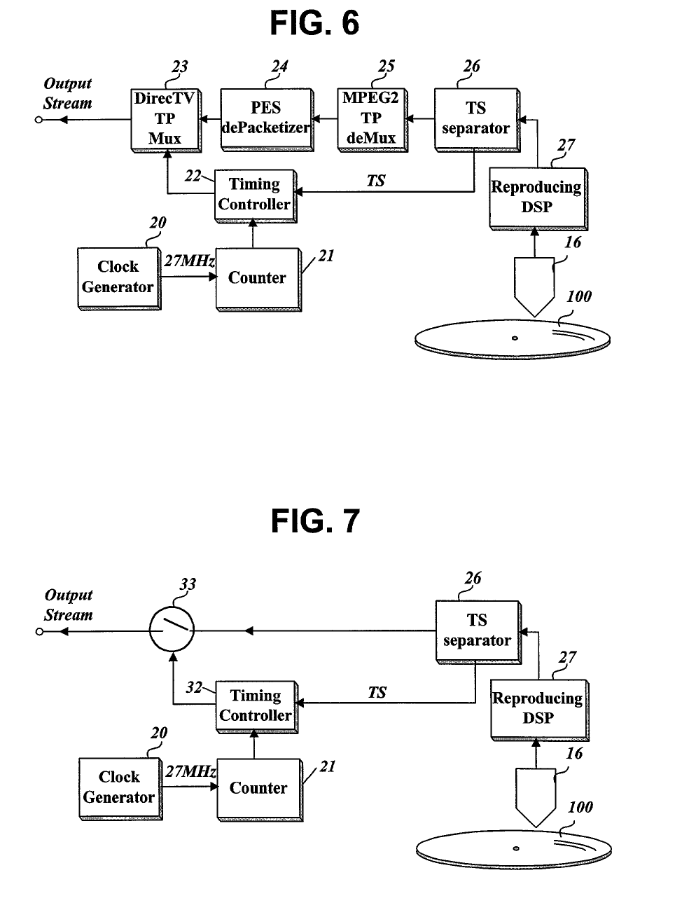

FIG. 6 is a block diagram of an apparatus reproducing data stream recorded in accordance with the above embodiment of the present invention.

The reproducing apparatus of FIG. 6 comprises an optical pickup 18 picking up signals recorded on the writable HD-DVD 100; a reproducing DSP 27 processing the picked-up signals to restore original digital data stream; a TS separator 26 slicing the restored digital data stream into 192-byte pieces and then separating each sliced stream piece into head 4-byte time information and a 188-byte M-TP; an MPEG2 TP demux 25 removing each 4-byte header of the successive M-TPs outputted from the TS separator 26; a PES depacketizer 24 collecting data from a plurality of header-removed M-TPs outputted from the MPEG2 TP demux 25 to construct a PES packet and then discarding a PES header of the constructed PES packet to output an A/V elementary stream; a DirecTV mux 23 slicing the A/V elementary stream to produce a series of 130-byte D-TPs; and a timing controller 22 determining transmitting time of a held D-TP in the DirecTV mux 23 based on both a current count of a counter 21 counting a 27 MHz clock produced by a clock generator 20 and average time difference between contiguous several 4-byte TSs from the TS separator 26.

In the reproducing apparatus of FIG. 6, the TS separator 26 slices the data stream from the reproducing DSP 27 into 192-byte stream pieces and then separates each stream piece into a 4-byte head TS and a 188-byte M-TP which are delivered to the timing controller 22 and the MPEG2 TP demux 25, respectively.

The MPEG2 TP demux 25 divides each M-TP outputted from the TS separator 26 into a 4-byte header and 184-byte data and then outputs data stream excluding the 4-byte header. While restoring the data stream outputted from the MPEG2 TP demux 25 to a series of PES packets, the PES depacketizer 24 checks the PES header of each PES packet to know whether a non-MPEG transport stream is encapsulated in a PES packet. If a non-MPEG transport stream is encapsulated, the PES depacketizer 24 outputs only PES data to the DirecTV demux 23 after discarding every PES header. Thusly-outputted PES data constitutes an A/V elementary stream.

The DirecTV TP mux 23 slices the A/V elementary stream from the PES depacketizer 24 to produce a series of 130-byte D-TPs, which are temporarily stored therein.

In the meantime, the timing controller 22 continues to calculate an average time difference ‘ATD’ between successive several, e.g., 3˜5 TSs received from the TS separator 25. Also, it multiplies the average time difference by some ratio ‘r’, e.g., ‘128(data length of a D-TP)/184(data length of an M-TP)’ whenever the average time difference ‘ATD’ is updated.

While conducting such calculation, the timing controller 22 keeps comparing the calculated value ‘r×ATD’ with count difference between the current count of the counter 21 and a memorized previous one counted at the time when a previous D-TP was transmitted. And, whenever the compared two values are equal the timing controller 22 commands the DirecTV TP mux 23 to transmit the stored D-TPs one by one.

Consequently, a series of 130-byte D-TPs recorded sequentially on the HD-DVD 100 is reproduced and transmitted sequentially as it is received.

FIG. 7 is a block diagram of another apparatus reproducing data stream recorded in accordance with the above embodiment of the present invention.

The reproducing apparatus of FIG. 7 is for transmitting a reproduced data stream not in original transport stream format but in MPEG transport stream format. The apparatus of FIG. 7 is different from that of FIG. 6 in that the MPEG2 TP demux 25 and the PES depacketizer 24 are removed and the DirecTV TP mux 23 is replaced with a data holder 33 holding a received M-TP until its transmission is commanded by a timing controller 32.

Furthermore, the timing controller 32 determines transmission time of a held packet in the data holder 33 in a different manner than the apparatus of FIG. 6 does.

In the reproducing apparatus of FIG. 7, the TS separator 26 slices the data stream from the reproducing DSP 27 into 192-byte stream pieces and then separates each stream piece into a 4-byte head TS and a 188-byte M-TP which are delivered to the timing controller 32 and the data holder 33, respectively. The data holder 33 holds transmission of the received M-TP until the timing controller 32 requests to.

The timing controller 32 continues to monitor the time difference between a current count of the counter 21 and a memorized previous one counted at the time when a previous M-TP was transmitted. When the monitored time difference is equal to a TS difference between the just-received TS and a TS of the previous M-TP already sent, the timing controller 32 commands the data holder 33 to transmit a M-TP held at present.

Consequently, a series of 130-byte D-TPs recorded sequentially is reproduced and is then transmitted in MPEG transport stream format, namely, in a series of M-TPs.

The above-explained apparatus and method of recording/reproducing digital TV broadcast data on/from a recording medium can record any type of transport stream in a predetermined recording format and reproduce recorded transport stream to an original type of transport stream, whereby an applicability of a digital recorder is improved.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of recording digital broadcast signal, comprising the steps of:
(a) receiving a digital broadcast signal composed of transport packets of a first format;
(b) restoring an A/V elementary stream from data contained in the received transport packets of the first format;
(c) slicing the restored A/V elementary stream into a predetermined-sized stream pieces to produce transport packets of a second format, a transport packet of the first format being different in length from that of the second format; and
(d) writing the produced transport packets of the second format on a recording medium.

2. The method of claim 1, wherein said step (c) makes a packet of a third format out of the restored A/V elementary stream, and slices the packet of the third format to produce transport packets of the second format.

3. The method of claim 2, wherein a packet of the third format is a PES (Packetized Elementary Stream) packet defined in MPEG (Moving Picture Experts Group) standard.

4. The method of claim 2, wherein the packet of the third format includes a predetermined-sized header.

5. The method of claim 2, wherein said step (c) slices the packet of the third format into 184-byte stream pieces, adds a 4-byte header to each stream piece to produce a corresponding transport packet of the second format.

6. The method of claim 1, wherein said step (d) writes the produced transport packets of the second format on a recording medium after adding time information to each transport packet of the second format.

7. The method of claim 6, wherein the time information is based on a time when each transport packet of the second format is produced.

8. The method of claim 1, wherein a transport packet of the first format is a 130-byte packet defined in DirecTV, one of digital TV broadcast systems.

9. The method of claim 1, wherein a transport packet of the second format is a Transport Packet defined in MPEG (Moving Picture Experts Group) standard.

10. The method of claim 1, wherein said step (b) separates each transport packet of the first format into a 2-byte header and a 128-byte transport block, and demultiplexes data contained in each transport block to restore a part of the A/V elementary stream.

11. A method of reproducing digital broadcast data from a recording medium, comprising the steps of:
(a) reading a data stream from the recording medium and making transport packets of a second format out of the read data stream;
(b) restoring an A/V elementary stream from data contained in the transport packets of the second format;
(c) slicing the restored A/V elementary stream into a predetermined-sized stream pieces to produce transport packets of a first format, a transport packet of the first format being different in length from that of the second format; and
(d) transmitting the produced transport packets of the first format.

12. The method of claim 11, wherein said step (a) makes the transport packets of the second format out of the read data stream by separating predetermined-sized time information inserted periodically in the data stream.

13. The method of claim 12, wherein said step (d) calculates transmitting time of each transport packet of the first format based on time differences among the separated time information, and transmits each transport packet of the first format at each calculated transmitting time.

14. The method of claim 11, wherein said step (b) collects data from a plurality of transport packets of the second format, constructs a packet of a third format with the collected data, extracts a part of the A/V elementary stream from the constructed packet of the third format.

15. The method of claim 11, wherein a transport packet of the first format is a 130-byte packet defined in DirecTV, one of digital TV broadcast systems.

16. The method of claim 11, wherein a transport packet of the second format is a Transport Packet defined in MPEG (Moving Picture Experts Group) standard.

17. A method of reproducing digital broadcast data from a recording medium, comprising the steps of:
(a) reading a data stream from the recording medium wherein transport packets of a first format are encapsulated in the data stream;
(b) slicing the read data stream into a predetermined-sized stream pieces and separating each stream piece into a transport packet of a second format and time information added thereto; and
(c) calculating transmitting time of each transport packet of the second format based on the separated time information, and transmitting each transport packet of the second format at each calculated transmitting time.

18. An apparatus of recording digital broadcast signal, comprising:
a data converter receiving a digital broadcast signal composed of transport packets of a first format, restoring an A/V elementary stream from data contained in the received transport packets of the first format, and slicing the restored A/V elementary stream into a predetermined-sized stream pieces to produce transport packets of a second format, a transport packet of the first format being different in length from that of the second format; and
writing means writing the produced transport packets of the second format on a recording medium.

19. An apparatus of reproducing digital broadcast data from a recording medium, comprising:
reading means reading a data stream from the recording medium and making transport packets of a second format out of the read data stream; and
a data converter restoring an A/V elementary stream from data contained in the transport packets of the second format, slicing the restored A/V elementary stream into a predetermined-sized stream pieces to produce transport packets of a first format, and transmitting the produced transport packets of the first format wherein a transport packet of the first format being different in length from that of the second format.

20. An apparatus of reproducing digital broadcast data from a recording medium, comprising:
reading means reading a data stream from the recording medium wherein transport packets of a first format are encapsulated in the data stream;
a data converter slicing the read data stream into a predetermined-sized stream pieces and separating each stream piece into a transport packet of a second format and time information added thereto; and
a controller calculating transmitting time of each transport packet of the second format based on the separated time information, and controlling said data converter to transmit each transport packet of the second format at each calculated transmitting time.
